(19) United States
(12) Patent Application Publication
(10) Pub. No.: US 2006/0146868 A1
(43) Pub. Date: Jul. 6, 2006

(54) Device, system and method for selective aggregation of transmission streams

(75) Inventor: Boris Ginzburg, Haifa (IL)

Correspondence Address: PEARL COHEN ZEDEK LATZER, LLP, 1500 BROADWAY, 12TH FLOOR, NEW YORK, NY, 10036, US

(73) Assignee: INTEL CORPORATION

(21) Appl. No.: 11/028,540

(22) Filed: Jan. 5, 2005

(51) Int. Cl. H04L 1/00

(52) U.S. Cl. 370/465; 370/252

(57) ABSTRACT

Briefly, some embodiments of the invention provide devices, systems and methods for selective aggregation of transmission streams. For example, a method in accordance with an embodiment of the invention may include selectively aggregating a first transmission stream and a second transmission stream into an aggregated stream, based on a data-related characteristic of the first and second transmission streams.

### CROSS REFERENCE TO RELATED APPLICATIONS

This application is related to U.S. application Ser. No. 10/994,330, entitled “Apparatus and Method of Aggregation of Data Packets Streams”, filed on Nov. 23, 2004, and assigned to the assignee of the present application.

### BACKGROUND OF THE INVENTION

In the field of wireless communications, multiple transmission streams may be transmitted between a wireless communication station and a wireless access point. In accordance with IEEE 802.11e standard regarding Quality of Service (QoS), the station may transmit transmission streams individually, or may transmit them as an aggregated stream including all the streams that are pending for transmission. Although such aggregation may be intended for increased throughput, unfortunately, scheduling of all the transmission streams in an aggregated stream may raise various problems, for example, channel overbooking, inefficient performance, and decreased QoS and/or throughput.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a wireless communication system supporting selective transmission stream aggregation, in accordance with an exemplary embodiment of the invention;

FIG. 2 is a schematic block diagram illustration of a wireless communication station able to perform selective aggregation in accordance with an exemplary embodiment of the invention;

FIG. 3 is a schematic block diagram illustration of a wireless access point able to schedule selective transmission stream aggregation in accordance with an exemplary embodiment of the invention;

FIGS. 4A-4D are schematic illustrations of conceptual representations of multiple transmission streams and their selective aggregation in accordance with exemplary embodiments of the invention; and

FIG. 5 is a schematic flow-chart of a method of selectively aggregating transmission streams in accordance with an exemplary embodiment of the invention.

It will be appreciated that for simplicity and clarity of illustration, elements shown in the figures have not necessarily been drawn to scale For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

It should be understood that embodiments of the invention may be used in a variety of applications. Although the invention is not limited in this respect, embodiments of the invention may be used in conjunction with many apparatuses, for example, a transmitter, a receiver, a transceiver, a transmitter-receiver, a wireless communication station, a wireless communication device, a wireless Access Point (AP), a modem, a wireless modem, a personal computer, a desktop computer, a mobile computer, a laptop computer, a notebook computer, a Personal Digital Assistant (PDA) device, a tablet computer, a server computer, a network, a Local Area Network (LAN), a Wireless LAN (WLAN), devices and/or networks operating in accordance with existing 802.11a, 802.11b, 802.11e, 802.11g, 802.11i, 802.11n standards and/or future versions of the above standards, devices and/or networks using Hybrid Coordination Function (HCF) mechanism, devices and/or networks using HCF Controlled Channel Access (HCCA) mechanism, devices and/or networks using Enhanced Distributed Channel Access (EDCA) mechanism, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, or the like. It is noted that embodiments of the invention may be used in various other apparatuses, devices, systems and/or networks.

The term “transmission stream” as used herein may include, for example, a traffic stream, a stream of packets, a stream of frames, a stream of blocks, a stream of bits or bytes, or other suitable stream of data items.

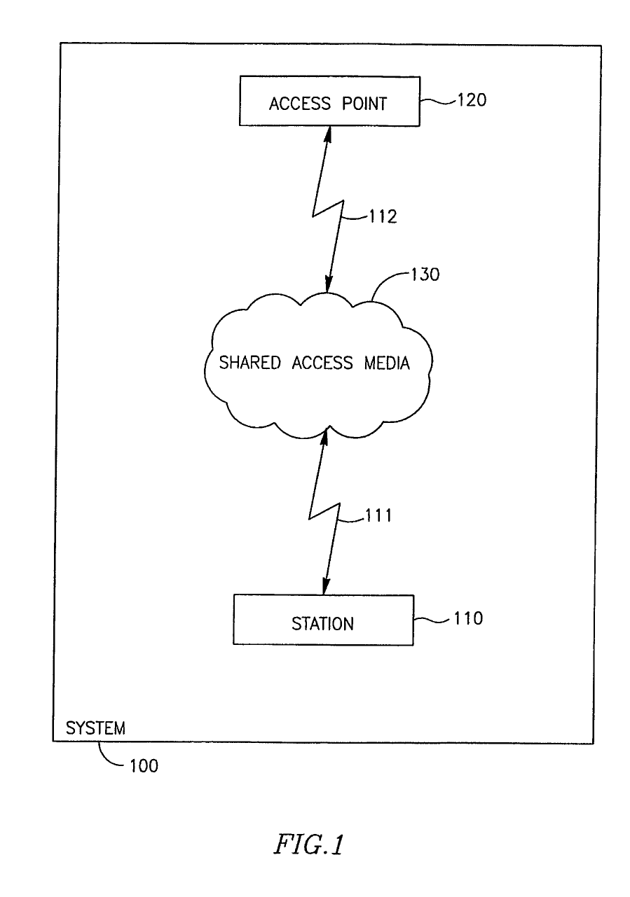

FIG. 1 schematically illustrates a block diagram of a wireless communication system 100, including a station 110 able to selectively aggregate transmission streams, and an access point 120 able to schedule selective transmission stream aggregation, in accordance with exemplary embodiments of the invention. System 100 may include, for example, one or more wireless communication stations, e.g., station 110, and one or more wireless access points, e.g., access point 120. Station 110 and access point 120 may communicate between themselves over a shared wireless media 130, for example, using wireless communication links 111 and 112, respectively. Although system 100 shows, for exemplary purposes, one station 110 and one access point 120, embodiments of the invention are not limited in this regard, and system 100 may include a plurality of stations and/or access points.

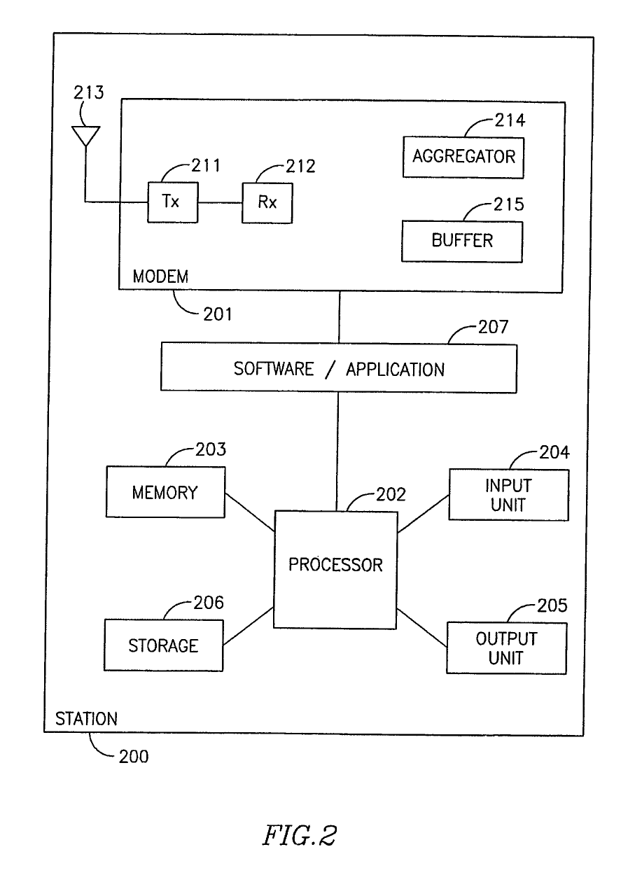

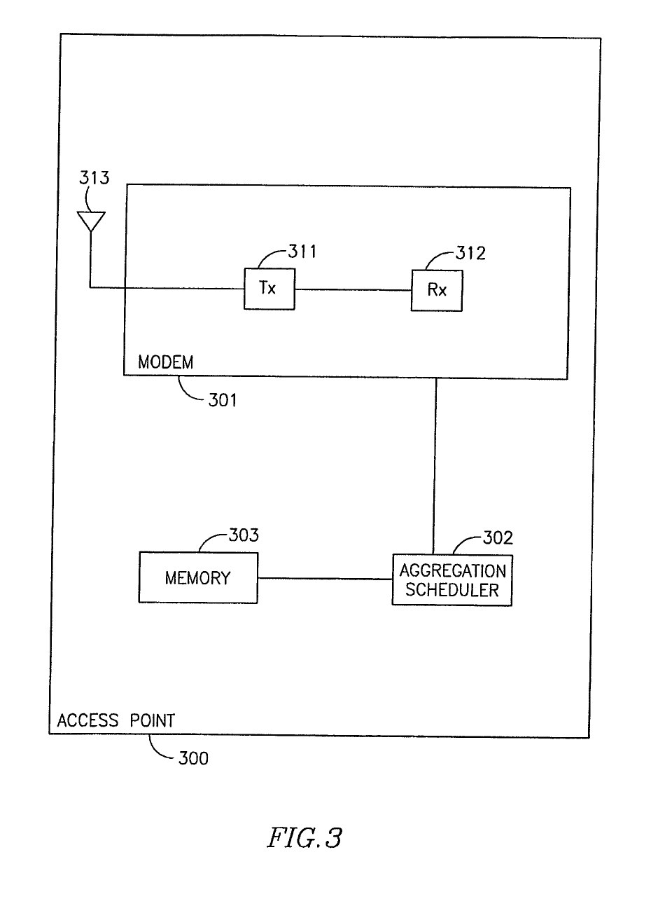

Station 110 may include, for example, a station similar to station 200 described below with reference to FIG. 2. Access point 120 may include, for example, an access point similar to access point 300 described below with reference to FIG. 3.

In some embodiments, for example, station 110 may selectively aggregate a first transmission stream and a second transmission stream into an aggregated stream, e.g., based on a characteristic of the first and second transmission streams. For example, the first and second transmission streams may be aggregated if they have a common or compatible property, characteristic or data type. The characteristic may be or may include, for example, data-related characteristic, real-time data or data-related characteristic, characteristic of data or real-time data included in one or more of the streams pending for transmission, or the like. Station 110 may transmit the selectively aggregated transmission stream to access point 120.

For example, in some embodiments, station 110 may selectively aggregate multiple transmission streams having the same or compatible data type into an aggregated transmission stream. For example, multiple streams having voice data may be aggregated into a first aggregated stream, and multiple streams having voice data may be aggregated into a second aggregated stream.

Although part of the discussion herein may relate, for example, to station 110 as the unit selectively aggregating transmission streams and/or transmitting a selectively aggregated stream to access point 120, embodiments of the invention are not limited in this regard. For example, in some embodiments, a selectively aggregated transmission stream may be created and transmitted by station 110 to other stations in system 100. Furthermore, in some embodiments, a selectively aggregated transmission stream may be created and transmitted by access point 120, for example, to station 110, to a plurality of stations, and/or to one or more other access points.

FIG. 2 schematically illustrates a block diagram of a wireless communication station 200 able to selectively aggregate transmission streams in accordance with exemplary embodiments of the invention. Station 200 may be an example of station 110 of FIG. 1.

Station 200 may include, for example, a modem 201, a processor 202, a memory unit 203, an input unit 204, an output unit 205, and a storage unit. Station 200 may further include other suitable hardware components and/or software components.

Processor 202 may include, for example, a Central Processing Unit (CPU), a Digital Signal Processor (DSP), a microprocessor, a controller, a chip, a microchip, or any other suitable multi-purpose or specific processor or controller.

Input unit 204 may include, for example, a keyboard, a mouse, a touch-pad, or other suitable pointing device or input device. Output unit 205 may include, for example, a Cathode Ray Tube (CRT) monitor, a Liquid Crystal Display (LCD) monitor, or other suitable monitor or display unit.

Memory unit 203 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units.

In some embodiments, a software component 207 may be stored, for example, in memory unit 203 and/or storage unit 206. Software component 207 may be executed by processor 202. In some embodiments, some operations required by software component 207 may be carried out by modem 201, for example, wireless transmission operations.

Modem 201 may include, for example, a wireless modem having, for example, a transmitter 211, a receiver 212, and an antenna 213. Transmitter 211 may include, for example, a Radio Frequency (RF) transmitter able to transmit RF signals. Receiver 212 may include, for example, a RF receiver able to receive signals RF signals. In some embodiments, transmitter 211 and receiver 212 may be implemented in the form of a transceiver, a transmitter-receiver, or one or more units able to perform separate or integrated functions of sending and/or receiving wireless communication signals, blocks, frames, transmission streams, packets, messages and/or data.

Antenna 213 may include an internal and/or external RF antenna. In some embodiments, for example, antenna 213 may include a dipole antenna, a monopole antenna, an omni-directional antenna, an end fed antenna, a circularly polarized antenna, a micro-strip antenna, a diversity antenna, or any other type of antenna suitable for sending and/or receiving wireless communication signals, blocks, frames, transmission streams, packets, messages and/or data.

In accordance with exemplary embodiments of the invention, modem 201 may include an aggregator 214 and a buffer 215. Aggregator 214 may include, for example, an aggregation controller, a controller, a processor, a circuit, a software component, or other unit able to perform selective aggregation in accordance with embodiments of the invention, as described in detail below. Buffer 215 may include, for example, a memory unit or storage unit able to store data which modem 201 may be required to transmit, e.g., during an aggregation process performed by aggregator 214, as described in detail below.

FIG. 3 schematically illustrates a block diagram of an access point 300 able to schedule selective transmission stream aggregation in accordance with exemplary embodiments of the invention. Access point 300 may be an example of access point 120 of FIG. 1.

Access point 300 may include, for example, a modem 301, an aggregation scheduler 302, and a memory unit 303. Access point 300 may further include other suitable hardware components and/or software components.

Memory unit 303 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units.

Modem 301 may include, for example, a wireless modem having, for example, a transmitter 311, a receiver 312, and an antenna 313. Transmitter 311 may include, for example, a Radio Frequency (RF) transmitter able to transmit RF signals. Receiver 312 may include, for example, a RF receiver able to receive signals RF signals. In some embodiments, transmitter 311 and receiver 312 may be implemented in the form of a transceiver, a transmitter-receiver, or one or more units able to perform separate or integrated functions of sending and/or receiving wireless communication signals, blocks, frames, transmission streams, packets, messages and/or data.

Antenna 313 may include an internal and/or external RF antenna. In some embodiments, for example, antenna 313 may include a dipole antenna, a monopole antenna, an omni-directional antenna, an end fed antenna, a circularly polarized antenna, a micro-strip antenna, a diversity antenna, or any other type of antenna suitable for sending and/or receiving wireless communication signals, blocks, frames, transmission streams, packets, messages and/or data.

Aggregation scheduler 302 may include, for example, a processor, a Central Processing Unit (CPU), a Digital Signal Processor (DSP), a microprocessor, a controller, a chip, a microchip, or any other suitable multi-purpose or specific processor or controller. In some embodiments, aggregation scheduler 302 may be implemented, for example, as a software component, a hardware component, a unit or sub-unit of a processor, a unit or sub-unit of a wireless modem, a unit or sub-unit of a transceiver, or the like.

In accordance with exemplary embodiments of the invention, receiver 312 may receive through antenna 313 a request to allow selective aggregation. In response to the request, aggregation scheduler 302 may, for example, produce a response having a schedule and/or a reservation for selective aggregation, as described in detail below. The response may be transmitted, for example, by transmitter 311 through antenna 313. The response and/or the request may be stored in memory unit 303.

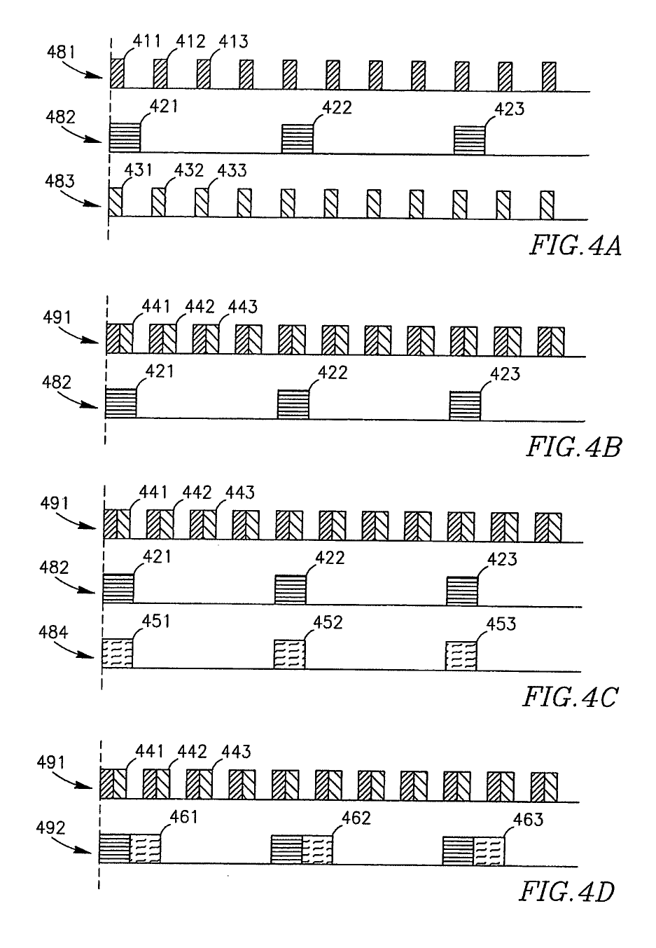

FIGS. 4A-4D schematically illustrate conceptual representations of multiple transmission streams and their selective aggregation in accordance with some exemplary embodiments of the invention. For exemplary purposes, part of the discussion herein may refer to the conceptual representations of FIGS. 4A-4D as stages of selective aggregation of transmission streams, e.g., to be transmitted from station 200 to access point 300. Embodiments of the invention are not limited to the four exemplary representations shown, and may include various other representations having various combinations of transmission streams and/or aggregated streams.

FIG. 4A schematically illustrates a conceptual representation of a first transmission stream 481 and a second transmission stream 482, which may be pending to be transmitted, e.g., by modem 201 of FIG. 2 based on a transmission request from processor 202.

In some embodiments, stream 481 may include data packets of a first type, for example, packets 411, 412 and 413. For example, data packets 411-413 may include voice data. In some embodiments, stream 482 may include data packets of a second type, for example, packets 421, 422 and 423. For example, data packets 421-423 may include video data.

As further shown in FIG. 4A, in some embodiments, a third transmission stream 483 may be pending to be transmitted, e.g., e.g., by modem 201 of FIG. 2 based on a transmission request from processor 202. In some embodiments, stream 483 may include data packets of the first type, for example, packets 431, 432 and 433. For example, data packets 411-413 may include voice data.

FIG. 4B schematically illustrates a conceptual representation of the third transmission stream 483, and a first aggregated transmission stream 491, which may be pending to be transmitted, e.g., by modem 201 of FIG. 2 based on a transmission request from processor 202.

As shown in FIG. 4B, streams 481 and 483 of FIG. 4A may be replaced by aggregated stream 491. For example, streams 481 and 483 of FIG. 4A may be selected for aggregation out of the pending streams 481-483 of FIG. 4A, e.g., if it is determined that streams 481 and 483 include data packets of the first type, whereas stream 482 includes data packets of the second, different type.

In some embodiments, the aggregated stream 491 may include aggregated data packets of the first type, for example, aggregated packets 441, 442 and 443. For example, aggregated packet 441 of FIG. 4B may correspond to packet 411 and packet 431 of FIG. 4A; aggregated packet 442 may of FIG. 4B correspond to packet 431 and packet 432 of FIG. 4A; and aggregated packet 443 of FIG. 4B may correspond to packet 413 and 433 of FIG. 4A.

In some embodiments, the aggregated stream 491 and the second stream 482 may be pending for transmission, or may be transmitted. It is noted that in some embodiments, further aggregation of stream 482 into aggregated stream 491 may be denied or rejected, for example, if it is determined that stream 482 includes data packets of a different type than the data packets of aggregated stream 491.

In accordance with some embodiments of the invention, selective aggregation may include selection of a plurality of streams, out of the streams pending for transmission, for example, based on a common or compatible parameter, characteristic, type, data type, property, priority value, packet size, or other criteria. The characteristic may be or may include, for example, data-related characteristic, real-time data or data-related characteristic, characteristic of data or real-time data included in one or more of the streams pending for transmission, or the like. For example, as illustrated in FIGS. 4A and 4B, two pending streams 481 and 483 may be aggregated into aggregated stream 491, whereas pending stream 482 may not be aggregated into aggregated stream 491, based on the data type of the packets of streams 481-483.

FIG. 4C schematically illustrates a conceptual representation of aggregated stream 491, stream 482, and a third transmission stream 484, which may be pending to be transmitted, e.g., by modem 201 of FIG. 2 based on a transmission request from processor 202.

In some embodiments, stream 484 may include data packets of the second type, for example, packets 451, 452 and 453. For example, data packets 451-453 may include video data.

FIG. 4D schematically illustrates a conceptual representation of aggregated stream 491 and an aggregated transmission stream 492, which may be pending to be transmitted, e.g., by modem 201 of FIG. 2 based on a transmission request from processor 202.

In some embodiments, for example, stream 482 and stream 484 of FIG. 4C may be selected for aggregation into aggregated stream 492 of FIG. 4D. Aggregated stream 492 may include aggregated data packets of the second type, for example, aggregated packets 461, 462 and 463. For example, aggregated packet 461 of FIG. 4D may correspond to packets 421 and 451 of FIG. 4C; aggregated packet 462 of FIG. 4D may correspond to packets 421 and 452 of FIG. 4C; and aggregated packet 463 of FIG. 4D may correspond to packets 423 and 453 of FIG. 4C.

In some embodiments, further aggregation of aggregated streams 491 and 492 may be avoided, denied or rejected, for example, if it is determined that aggregated stream 491 includes data packets of a different type than the data packets of aggregated stream 492.

In some embodiments, a stream or an aggregated stream pending for transmission may include a Traffic ID (TID) parameter. The value of the TID parameter of a stream or an aggregated stream may indicate, for example, the type of data packets of that stream or aggregated stream, respectively. For example, streams 481 and 483 may have a TID value indicating voice data, e.g., a value of 6, whereas streams 482 and 484 may have a TID value indicating video data, e.g., a value of 5. In accordance with exemplary embodiments of the invention, the TID value of a selectively aggregated stream may be the same as the value of one TID of the selectively aggregated streams. For example, aggregated stream 491 may have a TID value equal to the TID value of streams 481 or 483, e.g., a value of 6, whereas aggregated stream 492 may have a TID value equal to the TID value of streams 482 or 484, e.g., a value of 5.

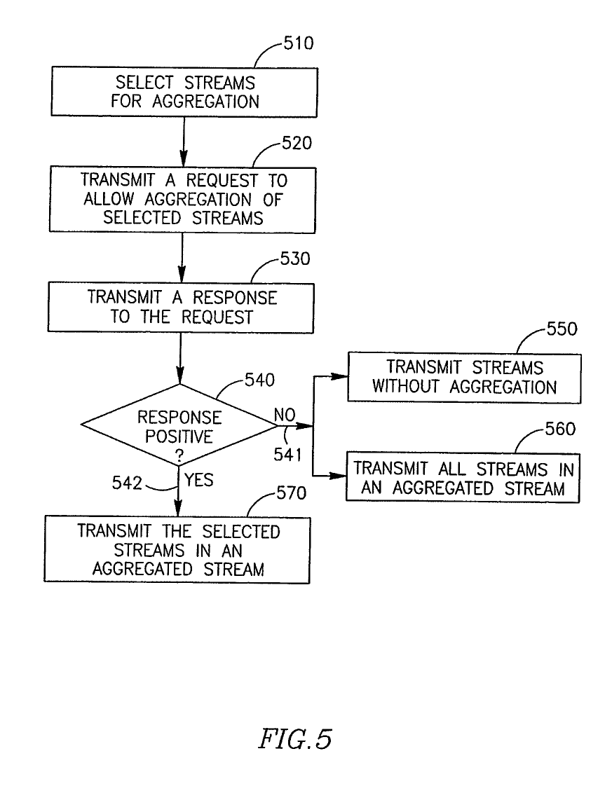

FIG. 5 is a schematic flow-chart of a method of selectively aggregating transmission streams in accordance with exemplary embodiments of the invention. Operations of the method may be implemented, for example, by system 100 of FIG. 1, by station 110 of FIG. 1, by access point 120 of FIG. 1, by station 200 of FIG. 2, by modem 201 of FIG. 2, by access point 300 of FIG. 3, by modem 301 of FIG. 3, or by other suitable stations, access points, controllers, modems, processors, units, devices, and/or systems.

As indicated at box 510, the method may include, for example, selecting multiple streams for aggregation out of a plurality of streams pending for transmission. This may be performed, for example, by station 200, e.g., using aggregator 214. The selection may be based, for example, on a common or compatible characteristic or property of the streams pending for transmission, or based on data type analysis of the streams pending for transmission.

In some embodiments, the selection may include, for example, selecting multiple transmission streams having the same or compatible data type into an aggregated transmission stream. For example, multiple streams having voice data may be selected for aggregation into a first aggregated stream, and multiple streams having video data may be selected for aggregation into a second aggregated stream.

In some embodiments, for example, the selection may be based on a type of content of data packets, on a type or ID or TID of data packets, or other characteristics, properties, conditions, criteria or parameters. For example, multiple streams having voice data may be selected for aggregation into a first aggregated stream, whereas multiple streams having video data may be selected for aggregation into a second aggregated stream.

In some embodiments, the selection may be based on service intervals or packet size analysis. For example, multiple streams having a relatively small average packet size may be selected for aggregation into a first aggregated stream, whereas multiple streams having a relatively large average packet size may be selected for aggregation into a second aggregated stream.

In some embodiments, the selection may be based on relative sensitivity of streams Quality of Service (QoS) to delays in transmission. For example, a voice transmission stream may be relatively sensitive to transmission delays, e.g., a voice stream having data encoded at approximately 4-160 kilobit per second may tolerate a transmission delay of approximately 50 milliseconds, and therefore voice streams may be selected for aggregation into a first aggregated stream. A video stream may be relatively less sensitive to transmission delays, e.g., a video transmission stream having data encoded at approximately 256 kilobit to 20 megabit per second may tolerate a transmission delay of approximately 100 milliseconds, and therefore video streams may be selected for aggregation into a second aggregated stream.

In some embodiments, the selection may be based on a priority value allocated to transmission streams, for example, set by a user or in accordance with a standard, e.g., IEEE 802.11e. For example, in some embodiments, the selection may be performed based on Traffic ID (TID) values, priority values or type descriptions allocated to transmission streams, e.g., “best effort” priority, “excellent effort” priority, “video” priority, “voice” priority, “background” priority, “controlled load” priority, “network control” priority, or the like. For example, transmission streams having the same allocated priority may be selected for aggregation in one group, separately from streams having a different allocated priority.

As indicated at box 520, the method may include, for example, transmitting a request to allow aggregation of the selected streams. The request may be transmitted, for example, by station 110 to access point 120. In some embodiments, for example, the request may include a request to aggregate a first transmission stream and a second transmission stream having the same type or compatible types of data packets. In one embodiment, the request may include a request to aggregate some, but not all, of the streams pending for transmission.

In some embodiments, the request may be sent, for example, in a dedicated frame, in a “ADDTS_REQUEST” frame or data item, or in a frame including the request and other data, e.g., in a frame including transmission stream description (“TSPEC”) and/or transmission stream classifier (“TCLASS”). In some embodiments, the request may include data indicating that aggregation of the selected streams is requested, for example, by setting a value of a parameter, e.g., by setting a value of “1” in an “aggregation bit” field of a header packet. In some embodiments, the request may include data indicating the type of data for which the aggregation of selected streams is requested, for example, by setting a value of a parameter, e.g., by setting a pre-defined value in a four-bit Traffic Stream ID (TID) field or parameter.

As indicated at box 530, the method may include, for example, transmitting a response to the request to allow aggregation of the selected streams. For example, access point 120 may transmit the response to station 110. The response may be transmitted, for example, in a dedicated frame, in a “ADDTS_RESPONSE” frame or data item, or in a frame including the response and other data. In some embodiments, the response may be included, for example, in a QoS POLL frame or message sent by access point 120 to station 110.

In some embodiments, the response may include data bits indicating a denial of the request. Alternatively, the response may include data bits indicating an approval of the request, and optionally a schedule, a reservation, an allocated time period or slot, an allocated bandwidth, or instructions for transmission of the aggregated stream. For example, in some embodiments, the response may include data indicating that a time slot or a bandwidth is reserved for transmission of the aggregated stream.

As indicated at box 540, the method may include, for example, determining whether the request to allow aggregation of the selected streams is approved. For example, the determination may be performed by station 110, e.g., by aggregator 214, based on the response received from access point 120.

As indicated by arrow 541, if the aggregation of the selected streams is not approved, then the method may not aggregate the selected streams. In some embodiments, as indicated at box 550, the method may include denying aggregation of substantially all streams pending for transmission, e.g., such that substantially all streams pending for transmission may be transmitted individually and without aggregation. In alternate embodiments, as indicated at box 560, the method may include aggregating substantially all the streams pending for transmission. In some embodiments, the determination whether to perform the operations of box 550 or the operations of box 560 may be based on a pre-defined setting or parameter, for example, a value of a Registry key in Microsoft (RTM) Windows (RTM).

Alternatively, as indicated by arrow 542, if aggregation of the selected streams is approved, then the method may include transmitting an aggregated stream including the streams that were selected for aggregation in the operations of box 510. The transmission of the aggregated stream may include transmission of some, but not all, of the streams pending for transmission. The transmission may be performed in accordance with parameters or instructions included in the approval response, e.g., parameters indicating time slot or bandwidth allocated for the transmission of the aggregated stream. The transmission may be performed, for example, by station 110 to access point 120.

Although part of the discussion herein may relate, for exemplary purposes, to selection of transmission streams for aggregation, embodiments of the invention are not limited in this regard, and may include, for example, selection and aggregation of packets, frames, blocks, messages, files, or other data items.

Other suitable operations or sets of operations may be used in accordance with embodiments of the invention.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of die invention may include buffers, registers, stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by station 110, by access point 120, by station 200, by modem 201, by processor 202, by modem 301, by processor 302, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 203 or memory unit 303), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
selectively aggregating a first transmission stream and a second transmission stream into an aggregated stream, based on a data-related characteristic of said first and second transmission streams.

2. The method of claim 1, wherein selective aggregating comprises aggregating said first and second transmission streams if said characteristic of said first transmission stream is compatible with said characteristic of said second transmission stream.

3. The method of claim 1, wherein selectively aggregating comprises aggregating said first and second transmission streams if said first and second transmission streams include data of the same type.

4. The method of claim 1, wherein selectively aggregating comprises selectively aggregating based on priority values associated with said first and second transmission streams.

5. The method of claim 1, wherein selectively aggregating comprises selectively aggregating based on an average packet size of said first and second transmission streams.

6. The method of claim 1, wherein selectively aggregating comprises selectively aggregating based on sensitivity of said first and second transmission streams to transmission delays.

7. The method of claim 1, comprising transmitting a request to allow selective aggregation.

8. The method of claim 7, comprising, in response to said request, transmitting a message allowing selective aggregation and including a transmission schedule for said aggregated stream.

9. The method of claim 8, comprising transmitting said aggregated stream.

10. The method of claim 1, comprising denying aggregation of a third transmission stream into said aggregated stream.

11. An apparatus comprising:
an aggregator to selectively aggregate a first transmission stream and a second transmission stream into an aggregated stream, based on a data-related characteristic of said first and second transmission streams.

12. The apparatus of claim 11, wherein said aggregator is to aggregate said first and second transmission streams if said characteristic of said first transmission stream is compatible with said characteristic of said second transmission stream.

13. The apparatus of claim 11, wherein said aggregator is to aggregate if said first and second transmission streams include data of the same type.

14. The apparatus of claim 11, wherein said aggregator is to selectively aggregate based on priority values associated with said first and second transmission streams.

15. The apparatus of claim 11, wherein said aggregator is to selectively aggregate based on an average packet size of said first and second transmission streams.

16. The apparatus of claim 11, wherein said aggregator is to selectively aggregate based on sensitivity of said first and second transmission streams to transmission delays.

17. The apparatus of claim 11, wherein said first and second transmission streams comprise video transmission streams.

18. The apparatus of claim 11, wherein said first and second transmission streams comprise voice transmission streams.

19. The apparatus of claim 11, wherein said aggregator is to transmit a request to allow selective aggregation.

20. The apparatus of claim 19, wherein said aggregator is to receive a response allowing selective aggregation and including a transmission schedule for said aggregated stream.

21. The apparatus of claim 20, wherein said aggregator is to transmit said aggregated stream.

22. The apparatus of claim 11, wherein said aggregator is to deny aggregation of a third transmission stream into said aggregated stream.

23. The apparatus of claim 11, comprising a dipole antenna.

24. A wireless communication system comprising:
a wireless communication station to selectively aggregate a first transmission stream and a second transmission stream into an aggregated stream, based on a data-related characteristic of said first and second transmission streams.

25. The wireless communication system of claim 24, wherein said wireless communication station is to transmit a request to allow selective aggregation.

26. The wireless communication system of claim 25, further comprising a wireless access point to transmit, in response to said request, a response allowing selective aggregation.

27. The wireless communication system of claim 26, wherein said response comprises a transmission schedule for said aggregated stream.

28. A machine-readable medium having stored thereon a set of instructions that, if executed by a machine, cause the machine to perform a method comprising:
selectively aggregating a first transmission stream and a second transmission stream into an aggregated stream, based on a data-related characteristic of said first and second transmission streams.

29. The machine-readable medium of claim 28, wherein the instructions result in:
transmitting a request to allow selective aggregation.

30. The machine-readable medium of claim 29, wherein the instructions result in:
receiving a response allowing selective aggregation and including a transmission schedule for said aggregated stream.
